(19) United States
(12) Patent Application Publication
(10) Pub. No.: US 2022/0063676 A1
(43) Pub. Date: Mar. 3, 2022

(54) METHOD AND APPARATUS TO PROVIDE DYNAMIC SOLUTIONS FOR AUTONOMOUS TRANSITION REGIONS

(71) Applicant: HERE Global B.V., Eindhoven (NL)

(72) Inventors: Jerome BEAUREPAIRE, Berlin (DE); Leon STENNETH, Chicago, IL (US); Jeremy Michael YOUNG, Chicago, IL (US)

(21) Appl. No.: 17/090,561

(22) Filed: Nov. 5, 2020

Related U.S. Application Data
(60) Provisional application No. 63/071,176, filed on Aug. 27, 2020.

(51) Int. Cl. B60W 60/00; B60W 50/14

(52) U.S. Cl. CPC B60W 60/0051; B60W 50/14; B60W 2756/10; B60W 2555/60; B60W 2556/55

(57) ABSTRACT

A method, apparatus and computer program product are provided for identifying and providing dynamic solutions for improvement of autonomous transition regions. In the context of a method, the method receives autonomous transition data associated with at least one autonomous transition region from at least one autonomous vehicle, and based at least on the autonomous transition data, determines one or more dynamic solutions for autonomous transitions within the at least one autonomous transition region. The method also generates a recommendation comprising at least indications of the one or more dynamic solutions and causes transmission of the recommendation to at least one external source.

### CROSS-REFERENCE TO RELATED APPLICATIONS

This application claims the benefit of U.S. Provisional Application No. 63/071,176, filed Aug. 27, 2020, the entire contents of which are incorporated herein by reference.

### TECHNOLOGICAL FIELD

An example embodiment relates generally to a method, apparatus and computer program product for identifying dynamic solutions for autonomous transition regions and, more particularly, for providing the dynamic solutions for improvement of travel over a road network including the autonomous transition regions.

### BACKGROUND

An autonomous vehicle is a vehicle including automated mechanisms for performing one or more aspects of vehicle control that have been conventionally performed by the driver. As autonomous vehicles are adopted, several benefits may be realized. For example, vehicle collisions may be reduced because computers can perform driving tasks more consistently and make fewer errors than human operators.

Autonomous vehicles may exhibit different levels of autonomy. Some autonomous vehicles may be equipped with autonomous functionalities such as lane keep assist and cruise control, but may lack the ability to autonomously control steering, accelerating, and braking. Other vehicles may be fully autonomous and able to self-drive with or without an occupant in the vehicle.

Certain regions along a route may influence autonomy levels. For example, in some regions, a vehicle may be required to transition to a lower level of autonomy (e.g., require driver intervention and/or control). However, these regions may lack suitable infrastructure to manage such transitions, potentially leading to congestion and neutralized/stalled vehicles.

### BRIEF SUMMARY

A method, apparatus and computer program product are therefore provided in accordance with an example embodiment in order to identify and provide dynamic solutions to improve autonomous transition regions. By identifying dynamic solutions and analyzing resulting autonomous transition region behavior, congestion along roadways may be alleviated, a safe and improved ride experience for passengers of autonomous vehicles may be provided, and load upon a network may be reduced.

In an example embodiment, an apparatus is provided comprising at least one processor and at least one memory storing computer program code with the at least one memory and the computer program code being configured to, with the processor, cause the apparatus to at least receive autonomous transition data from at least one autonomous vehicle. The autonomous transition data is associated with at least one autonomous transition region. The at least one memory and the computer program code are further configured to, with the processor, cause the apparatus to determine, based at least on the autonomous transition data, one or more dynamic solutions for autonomous transitions within the at least one autonomous transition region. The at least one memory and the computer program code are further configured to, with the processor, cause the apparatus to generate a recommendation comprising at least indications of the one or more dynamic solutions. The at least one memory and the computer program code are further configured to, with the processor, cause the apparatus to cause transmission of the recommendation to at least one external source.

The at least one memory and the computer program code of an example embodiment are further configured to, with the processor, cause the apparatus to update one or more parameters associated with the at least one autonomous transition region based at least on the received autonomous transition data. In some embodiments of the apparatus, the one or more dynamic solutions are determined based further on the one or more updated parameters associated with the at least one autonomous transition region. In some embodiments of the apparatus, the one or more dynamic solutions comprise a real-time or near real-time traffic adjustment, and the at least one external source comprises an authoritative body associated with the at least one autonomous transition region.

The at least one memory and the computer program code of an example embodiment configured to cause transmission of the recommendation to the at least one external source are further configured to, with the processor, cause the apparatus to determine a priority level for the recommendation based at least on a cost reduction for the at least one autonomous vehicle, and cause transmission of the recommendation to the at least one external source such that the recommendation is prioritized based on the priority level relative to one or more other recommendations.

In some embodiments of the apparatus, the cost reduction comprises at least one of a monetary cost or a temporal cost. In some embodiments of the apparatus, the one or more dynamic solutions comprise a telecommunications network coverage increase, and the at least one external source comprises a telecommunications service provider.

In another example embodiment, a method is provided including receiving autonomous transition data from at least one autonomous vehicle. The autonomous transition data is associated with at least one autonomous transition region. The method further includes causing the apparatus to determine, based at least on the autonomous transition data, one or more dynamic solutions for autonomous transitions within the at least one autonomous transition region. The method further includes generating a recommendation comprising at least indications of the one or more dynamic solutions. The method further includes causing transmission of the recommendation to at least one external source.

The method of an example embodiment further includes updating one or more parameters associated with the at least one autonomous transition region based at least on the received autonomous transition data. In some embodiments of the method, the one or more dynamic solutions are determined based further on the one or more updated parameters associated with the at least one autonomous transition region.

In some embodiments of the method, the one or more dynamic solutions comprise a real-time or near real-time traffic adjustment, and the at least one external source comprises an authoritative body associated with the at least one autonomous transition region.

In some embodiments of the method, causing transmission of the recommendation to the at least one external source further comprises determining a priority level for the recommendation based at least on a cost reduction for the at least one autonomous vehicle, and causing transmission of the recommendation to the at least one external source such that the recommendation is prioritized based on the priority level relative to one or more other recommendations.

In some embodiments of the method, the cost reduction comprises at least one of a monetary cost or a temporal cost. In some embodiments of the method, the one or more dynamic solutions comprise a telecommunications network coverage increase, and the at least one external source comprises a telecommunications service provider.

In an example embodiment, a computer program product is provided that includes a non-transitory computer readable medium having program code portions stored thereon with the program code portions being configured, upon execution, to receive autonomous transition data from at least one autonomous vehicle. The autonomous transition data is associated with at least one autonomous transition region. The program code portions are also configured to determine, based at least on the autonomous transition data, one or more dynamic solutions for autonomous transitions within the at least one autonomous transition region. The program code portions are also configured to generate a recommendation comprising at least indications of the one or more dynamic solutions. The program code portions are also configured to cause the apparatus to cause transmission of the recommendation to at least one external source.

The program code portions of an example embodiment are also configured to update one or more parameters associated with the at least one autonomous transition region based at least on the received autonomous transition data. In some embodiments of the computer program product, the one or more dynamic solutions are determined based further on the one or more updated parameters associated with the at least one autonomous transition region.

In some embodiments of the computer program product, the one or more dynamic solutions comprise a real-time or near real-time traffic adjustment, and the at least one external source comprises an authoritative body associated with the at least one autonomous transition region. The program code portions of an example embodiment configured to cause transmission of the recommendation to the at least one external source are also configured to determine a priority level for the recommendation based at least on a cost reduction for the at least one autonomous vehicle, and cause transmission of the recommendation to the at least one external source such that the recommendation is prioritized based on the priority level relative to one or more other recommendations.

In some embodiments of the computer program product, the cost reduction comprises at least one of a monetary cost or a temporal cost. In some embodiments of the computer program product, the one or more dynamic solutions comprise a telecommunications network coverage increase, and the at least one external source comprises a telecommunications service provider.

In another example embodiment, an apparatus is provided including means for receiving autonomous transition data from at least one autonomous vehicle. The autonomous transition data is associated with at least one autonomous transition region. The apparatus further includes means for causing the apparatus to determine, based at least on the autonomous transition data, one or more dynamic solutions for autonomous transitions within the at least one autonomous transition region. The apparatus further includes means for generating a recommendation comprising at least indications of the one or more dynamic solutions. The apparatus further includes means for causing transmission of the recommendation to at least one external source.

The apparatus of an example embodiment further includes means for updating one or more parameters associated with the at least one autonomous transition region based at least on the received autonomous transition data. In some embodiments of the apparatus, the one or more dynamic solutions are determined based further on the one or more updated parameters associated with the at least one autonomous transition region.

In some embodiments of the apparatus, the one or more dynamic solutions comprise a real-time or near real-time traffic adjustment, and the at least one external source comprises an authoritative body associated with the at least one autonomous transition region. In some embodiments of the apparatus, the means for causing transmission of the recommendation to the at least one external source further comprises means for determining a priority level for the recommendation based at least on a cost reduction for the at least one autonomous vehicle, and means for causing transmission of the recommendation to the at least one external source such that the recommendation is prioritized based on the priority level relative to one or more other recommendations.

In some embodiments of the apparatus, the cost reduction comprises at least one of a monetary cost or a temporal cost. In some embodiments of the apparatus, the one or more dynamic solutions comprise a telecommunications network coverage increase, and the at least one external source comprises a telecommunications service provider.

In a further example embodiment, a method is provided including receiving autonomous transition data from at least one autonomous vehicle. The autonomous transition data is associated with at least one autonomous transition region. The method also includes determining, based at least on the autonomous transition data, one or more dynamic solutions for autonomous transitions within the at least one autonomous transition region. The method also includes generating a recommendation comprising at least indications of the one or more dynamic solutions. The method also includes causing transmission of the recommendation to at least one controlling device.

The method of an example embodiment further includes updating one or more parameters associated with the at least one autonomous transition region based at least on the received autonomous transition data. In some embodiments of the method, the one or more dynamic solutions are determined based further on the one or more updated parameters associated with the at least one autonomous transition region.

In some embodiments of the method, the one or more dynamic solutions comprise a real-time or near real time traffic adjustment, and the at least one controlling device comprises a controlling device associated with an external authoritative body associated with the at least one autonomous transition region. In some embodiments of the method, causing transmission of the recommendation to the at least one controlling device further includes determining a priority level for the recommendation based at least on a cost reduction for the at least one autonomous vehicle, and causing transmission of the recommendation to the at least one controlling device such that the recommendation is prioritized based on the priority level relative to one or more other recommendations.

In some embodiments of the method, the cost reduction comprises at least one of a monetary cost reduction or a temporal cost reduction. In some embodiments of the method, the one or more dynamic solutions comprise at least one of a telecommunications network coverage increase or real-time or near real time traffic adjustment.

In a further example embodiment, an apparatus is provided including means for receiving autonomous transition data from at least one autonomous vehicle. The autonomous transition data is associated with at least one autonomous transition region. The apparatus also includes means for determining, based at least on the autonomous transition data, one or more dynamic solutions for autonomous transitions within the at least one autonomous transition region. The apparatus also includes means for generating a recommendation comprising at least indications of the one or more dynamic solutions. The apparatus also includes means for causing transmission of the recommendation to at least one controlling device.

The apparatus of an example embodiment further includes means for updating one or more parameters associated with the at least one autonomous transition region based at least on the received autonomous transition data. In some embodiments of the apparatus, the one or more dynamic solutions are determined based further on the one or more updated parameters associated with the at least one autonomous transition region.

In some embodiments of the apparatus, the one or more dynamic solutions comprise a real-time or near real time traffic adjustment, and the at least one controlling device comprises a controlling device associated with an external authoritative body associated with the at least one autonomous transition region.

In some embodiments of the apparatus, the means for causing transmission of the recommendation to the at least one controlling device further includes means for determining a priority level for the recommendation based at least on a cost reduction for the at least one autonomous vehicle, and means for causing transmission of the recommendation to the at least one controlling device such that the recommendation is prioritized based on the priority level relative to one or more other recommendations.

In some embodiments of the apparatus, the cost reduction comprises at least one of a monetary cost reduction or a temporal cost reduction. In some embodiments of the apparatus, the one or more dynamic solutions comprise at least one of a telecommunications network coverage increase or real-time or near real time traffic adjustment.

In a further example embodiment, an apparatus is provided comprising at least one processor and at least one memory storing computer program code with the at least one memory and the computer program code being configured to, with the processor, cause the apparatus to at least receive autonomous transition data from at least one autonomous vehicle. The autonomous transition data is associated with at least one autonomous transition region. The at least one memory and the computer program code are further configured to, with the processor, cause the apparatus to determine, based at least on the autonomous transition data, one or more dynamic solutions for autonomous transitions within the at least one autonomous transition region. The at least one memory and the computer program code are further configured to, with the processor, cause the apparatus to generate a recommendation comprising at least indications of the one or more dynamic solutions. The at least one memory and the computer program code are further configured to, with the processor, cause the apparatus to cause transmission of the recommendation to at least one controlling device.

The at least one memory and the computer program code of an example embodiment are further configured to, with the processor, cause the apparatus to update one or more parameters associated with the at least one autonomous transition region based at least on the received autonomous transition data. In some embodiments of the apparatus, the one or more dynamic solutions are determined based further on the one or more updated parameters associated with the at least one autonomous transition region.

In some embodiments of the apparatus, the one or more dynamic solutions comprise a real-time or near real time traffic adjustment, and the at least one controlling device comprises a controlling device associated with an external authoritative body associated with the at least one autonomous transition region.

The at least one memory and the computer program code of an example embodiment configured to cause transmission of the recommendation to the at least one controlling device are further configured to, with the processor, cause the apparatus to determine a priority level for the recommendation based at least on a cost reduction for the at least one autonomous vehicle, and cause transmission of the recommendation to the at least one controlling device such that the recommendation is prioritized based on the priority level relative to one or more other recommendations.

In some embodiments of the apparatus, the cost reduction comprises at least one of a monetary cost reduction or a temporal cost reduction. In some embodiments of the apparatus, the one or more dynamic solutions comprise at least one of a telecommunications network coverage increase or real-time or near real time traffic adjustment.

In a further example embodiment, a computer program product is provided that includes a non-transitory computer readable medium having program code portions stored thereon with the program code portions being configured, upon execution, to receive autonomous transition data from at least one autonomous vehicle. The autonomous transition data is associated with at least one autonomous transition region. The program code portions are also configured to determine, based at least on the autonomous transition data, one or more dynamic solutions for autonomous transitions within the at least one autonomous transition region. The program code portions are also configured to generate a recommendation comprising at least indications of the one or more dynamic solutions. The program code portions are also configured to cause transmission of the recommendation to at least one controlling device.

The program code portions of an example embodiment are further configured to update one or more parameters associated with the at least one autonomous transition region based at least on the received autonomous transition data. In some embodiments of the computer program product, the one or more dynamic solutions are determined based further on the one or more updated parameters associated with the at least one autonomous transition region.

In some embodiments of the computer program product, the one or more dynamic solutions comprise a real-time or near real time traffic adjustment, and the at least one controlling device comprises a controlling device associated with an external authoritative body associated with the at least one autonomous transition region.

The program code portions of an example embodiment configured to cause transmission of the recommendation to the at least one controlling device are further configured to determine a priority level for the recommendation based at least on a cost reduction for the at least one autonomous vehicle, and cause transmission of the recommendation to the at least one controlling device such that the recommendation is prioritized based on the priority level relative to one or more other recommendations.

In some embodiments of the computer program product, the cost reduction comprises at least one of a monetary cost reduction or a temporal cost reduction. In some embodiments of the computer program product, the one or more dynamic solutions comprise at least one of a telecommunications network coverage increase or real-time or near real time traffic adjustment.

In another example embodiment, an apparatus is provided including at least one processor and at least one memory storing computer program code with the at least one memory and the computer program code being configured to, with the processor, cause the apparatus to at least receive autonomous transition data from at least one autonomous vehicle. The autonomous transition data is associated with at least one autonomous transition region, and the autonomous transition region is associated with one or more dynamic solutions previously transmitted to an external source. The at least one memory and the computer program code are also configured to, with the processor, cause the apparatus to determine, based at least on the autonomous transition data, a change in autonomous transition frequency associated with the at least one autonomous transition region. The at least one memory and the computer program code are also configured to, with the processor, cause the apparatus to cause transmission of information related to the change in autonomous transition frequency associated with the at least one autonomous transition region to the external source.

In some embodiments of the apparatus, the change in autonomous transition frequency associated with the at least one autonomous transition region comprises a reduced amount of autonomous transitions within the autonomous transition region. The at least one memory and the computer program code of an example embodiment are further configured to, with the processor, cause the apparatus to update one or more parameters associated with the at least one autonomous transition region based at least on the received autonomous transition data.

In some embodiments of the apparatus, the change in autonomous transition frequency associated with the at least one autonomous transition region comprises an increased amount of autonomous transitions within the autonomous transition region. In some embodiments of the apparatus, the one or more dynamic solutions comprise a telecommunications network coverage increase. In some embodiments of the apparatus, the one or more dynamic solutions comprise a real-time or near real-time traffic adjustment.

In another example embodiment, a computer program product is provided that includes a non-transitory computer readable medium having program code portions stored thereon with the program code portions being configured, upon execution, to receive autonomous transition data from at least one autonomous vehicle. The autonomous transition data is associated with at least one autonomous transition region, and the autonomous transition region is associated with one or more dynamic solutions previously transmitted to an external source. The program code portions are also configured to determine, based at least on the autonomous transition data, a change in autonomous transition frequency associated with the at least one autonomous transition region. The program code portions are also configured to cause transmission of information related to the change in autonomous transition frequency associated with the at least one autonomous transition region to the external source.

In some embodiments of the computer program product, the change in autonomous transition frequency associated with the at least one autonomous transition region comprises a reduced amount of autonomous transitions within the autonomous transition region. The program code portions of an example embodiment are further configured to update one or more parameters associated with the at least one autonomous transition region based at least on the received autonomous transition data.

In some embodiments of the computer program product, the change in autonomous transition frequency associated with the at least one autonomous transition region comprises an increased amount of autonomous transitions within the autonomous transition region.

In some embodiments of the computer program product, the one or more dynamic solutions comprise a telecommunications network coverage increase. In some embodiments of the computer program product, the one or more dynamic solutions comprise a real-time or near real-time traffic adjustment.

In a further example embodiment, a method is provided including receiving autonomous transition data from at least one autonomous vehicle. The autonomous transition data is associated with at least one autonomous transition region, and the autonomous transition region is associated with one or more dynamic solutions previously transmitted to an external source. The method also includes determining, based at least on the autonomous transition data, a change in autonomous transition frequency associated with the at least one autonomous transition region. The method also includes causing transmission of information related to the change in autonomous transition frequency associated with the at least one autonomous transition region to the external source.

In some embodiments of the method, the change in autonomous transition frequency associated with the at least one autonomous transition region comprises a reduced amount of autonomous transitions within the autonomous transition region. The method of an example embodiment also includes updating one or more parameters associated with the at least one autonomous transition region based at least on the received autonomous transition data.

In some embodiments of the method, the change in autonomous transition frequency associated with the at least one autonomous transition region comprises an increased amount of autonomous transitions within the autonomous transition region. In some embodiments of the method, the one or more dynamic solutions comprise a telecommunications network coverage increase. In some embodiments of the method, the one or more dynamic solutions comprise a real-time or near real-time traffic adjustment.

In a further example embodiment, an apparatus is provided including means for receiving autonomous transition data from at least one autonomous vehicle. The autonomous transition data is associated with at least one autonomous transition region, and the autonomous transition region is associated with one or more dynamic solutions previously transmitted to an external source. The apparatus also includes means for determining, based at least on the autonomous transition data, a change in autonomous transition frequency associated with the at least one autonomous transition region. The apparatus also includes means for causing transmission of information related to the change in autonomous transition frequency associated with the at least one autonomous transition region to the external source.

In some embodiments of the apparatus, the change in autonomous transition frequency associated with the at least one autonomous transition region comprises a reduced amount of autonomous transitions within the autonomous transition region. The apparatus of an example embodiment also includes means for updating one or more parameters associated with the at least one autonomous transition region based at least on the received autonomous transition data.

In some embodiments of the apparatus, the change in autonomous transition frequency associated with the at least one autonomous transition region comprises an increased amount of autonomous transitions within the autonomous transition region. In some embodiments of the apparatus, the one or more dynamic solutions comprise a telecommunications network coverage increase. In some embodiments of the apparatus, the one or more dynamic solutions comprise a real-time or near real-time traffic adjustment.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment;

FIG. 2 is a flowchart illustrating the operations performed, such as by the apparatus of FIG. 1, in order to determine one or more dynamic solutions for autonomous transitions within at least one autonomous transition region in accordance with an example embodiment;

FIG. 3 is a flowchart illustrating the operations performed, such as by the apparatus of FIG. 1, in order to determine a priority level for a recommendation in accordance with an example embodiment; and

FIG. 4 is a flowchart illustrating the operations performed, such as by the apparatus of FIG. 1, in order to determine and provide information related to a change in autonomous transition frequency in accordance with an example embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

As described above, vehicles having autonomous functionalities (e.g., parking assist, lane change assist, lane keeping assist and/or the like) as well as fully autonomous vehicles (e.g., self-driving vehicles) have and will continue to improve conditions on roadways by reducing hazards such as distracted and/or impaired driving and other human errors. Such vehicles may be defined by a particular level of autonomy at which they operate. For example, a vehicle operating at “level 0” autonomy may issue warnings to a driver or may momentarily intervene but provides no sustained autonomous control. A vehicle operating at “level 1” autonomy may provide features such that the driver and the automated system share control of the vehicle (e.g., cruise control, parking assist, lane keeping assist, etc.).

A vehicle operating at “level 2” autonomy may comprise an automated system which takes full control of the vehicle, including accelerating, braking, and steering. However, the driver must monitor the automated driving and be prepared to intervene immediately at a time when the automated system fails to respond properly. A vehicle operating at “level 3” autonomy may allow the occupant to turn their attention away from driving tasks. The “level 3” vehicle will handle situations that call for an immediate response, such as emergency braking. However, the driver must still be prepared to intervene within some limited time when called upon by the vehicle to do so.

A vehicle operating at “level 4” autonomy may require no driver attention for safety. For example, the occupant of the vehicle may sleep and/or leave the driver's seat during a commute. Further, a vehicle operating at “level 5” autonomy may require no human intervention at all. For example, the vehicle may, in some instances, be empty of occupants and be equipped to self-navigate. Examples may include a robotic taxi service and/or delivery service.

Autonomous vehicles may further improve existing business models, such as ride share or taxi services. In this regard, autonomous vehicles may be utilized for ride share services, reducing the need for labor costs of human drivers and improving user experience of the ride share service. Further, autonomous vehicles may allow for more consistency and predictability so as to potentially reduce accidents and may be operated in a more efficient and cost-effective manner.

Within certain regions along a route, a vehicle may require disengagement from autonomous functionality (e.g., transition to a lower level of autonomy) and a passenger within the vehicle to assume manual control or more manual control of the vehicle, at least until the region is traversed. Likewise, within certain other regions, the vehicle may resume autonomous functionality, and/or transition to a different, higher level of autonomy (e.g., from level 3 to level 4). In some instances, the passenger may be required to direct the vehicle to resume autonomous control and/or change autonomy levels. In other instances, resumption of autonomous control and/or autonomous level transitions may be performed automatically by the vehicle. These regions are generally referenced as transition regions or autonomous transition regions.

As described herein, an autonomous level transition more generally includes any change in autonomy level. In this regard, an autonomous level transition is a change in the level of autonomy which in some embodiments results in a complete disconnection from autonomous functionality (e.g., to a manually-driven mode), but in other embodiments maintains some degree of autonomy with the level of autonomy changing (e.g., changing to a lower level of autonomy, referred to herein as a disengagement). Similarly, an autonomous level transition may be a change from a particular level of autonomy to a higher level of autonomy (e.g., from level 2 to level 4) or, in some embodiments a connection to autonomous functionality from a disengaged mode (e.g., a manually-driven mode), all referred to herein as an engagement.

Some examples of a region in which a vehicle may perform an engagement (herein referred to as an engagement region) may include a region such as a highway that includes straight paths and/or wide lanes, sparsely populated regions (e.g., country roads), regions with above average cellular coverage, and/or the like.

Some examples of a region that requires a disengagement (herein referred to as a disengagement region) may include a region undergoing road work (e.g., under construction, having one or more lane closures, and/or the like), a high pedestrian traffic area (e.g., bus stops, school zone crossings, and/or the like), a region experiencing inclement conditions (e.g., black ice, etc.), a region having roadways with high curvature and/or slope, and/or a region that experiences a poor cellular signal, thereby limiting communication with the vehicle.

Although one or more autonomous vehicles will disengage upon entering a particular disengagement region, not all autonomous vehicles need disengage upon encountering the disengagement region as some autonomous vehicles are capable of maintaining autonomy under certain conditions, such as when experiencing inclement conditions, while other autonomous vehicles are not so capable. Similarly, although one or more autonomous vehicles will engage (e.g., transition to a higher level of autonomy) upon entering or while within an engagement region, not all autonomous vehicles are capable of such higher levels of autonomy. For example, for some vehicles, the highest level of autonomy possible may be level 1 (e.g., vehicles having cruise control, parking assist, and the like, but no sustained self-driving capabilities). In this regard, such vehicles are not equipped to transition to a higher level of autonomy when in an engagement region allowing for, for example, level 3 autonomy.

As described above, certain autonomous transition regions may lack suitable infrastructure to manage autonomous transitions, such as disengagements, potentially leading to congestion, neutralized vehicles, and/or other unsafe conditions.

For example, a passenger of an autonomous vehicle may not be able to manually control the autonomous vehicle in the event of a disengagement. In this regard, the passenger may be impaired, disabled, intoxicated, lack appropriate licensure, and/or otherwise unable to manually control the autonomous vehicle. Such a passenger may utilize autonomous vehicles particularly for the autonomous features (e.g., self-driving) as a convenient way to travel.

However, disengagement regions may impose an inconvenience on such passengers, as well as passengers in general. For example, a vehicle approaching or within a disengagement region may be required to cease driving and park in an instance in which the passenger cannot manually control the vehicle. In some instances, the passenger and vehicle may be required to await a platoon vehicle to lead the vehicle through the disengagement region until autonomous functionality can resume. However, this may impose increased travel time and create an unsafe environment for the passenger if the disengagement region is in an unsafe area (e.g., low visibility, high crime, etc.). Some examples of disengagement regions having limited infrastructure to manage disengaged vehicles may include mountainous areas, narrow one-way streets, roads near bodies of water, areas experiencing inclement conditions (e.g., ice), and/or the like.

Further, engagement regions that lack infrastructure to allow vehicles to maximize autonomous capabilities may also reduce ride experience and safety of passengers. For example, an engagement region that would otherwise allow for vehicles to operate at level 5 autonomy (e.g., self-drive) may currently lack proper cellular coverage such that autonomous vehicles traversing the engagement regions are unable to communicate with Global Positioning Systems (GPS) or the like and, as a result, may require the autonomous vehicles to operate at a lower autonomy level, thereby potentially increasing the risk of human error (e.g., car accidents and/or the like) within the engagement region.

A method, apparatus and computer program product are provided in accordance with an example embodiment in order to identify and provide dynamic solutions for autonomous transition regions and analyze resulting autonomous transition region behavior.

The apparatus that is configured to identify and provide dynamic solutions for autonomous transition regions may be any of a wide variety of computing devices. For example, the apparatus may be embodied by a server, a computer workstation, a distributed network of computing devices, a personal computer, a navigation or mapping system, an advanced driver-assistance system (ADAS) or any other type of computing device including mobile computing devices, such as a mobile telephone, personal computer, tablet computer, personal navigation device or the like.

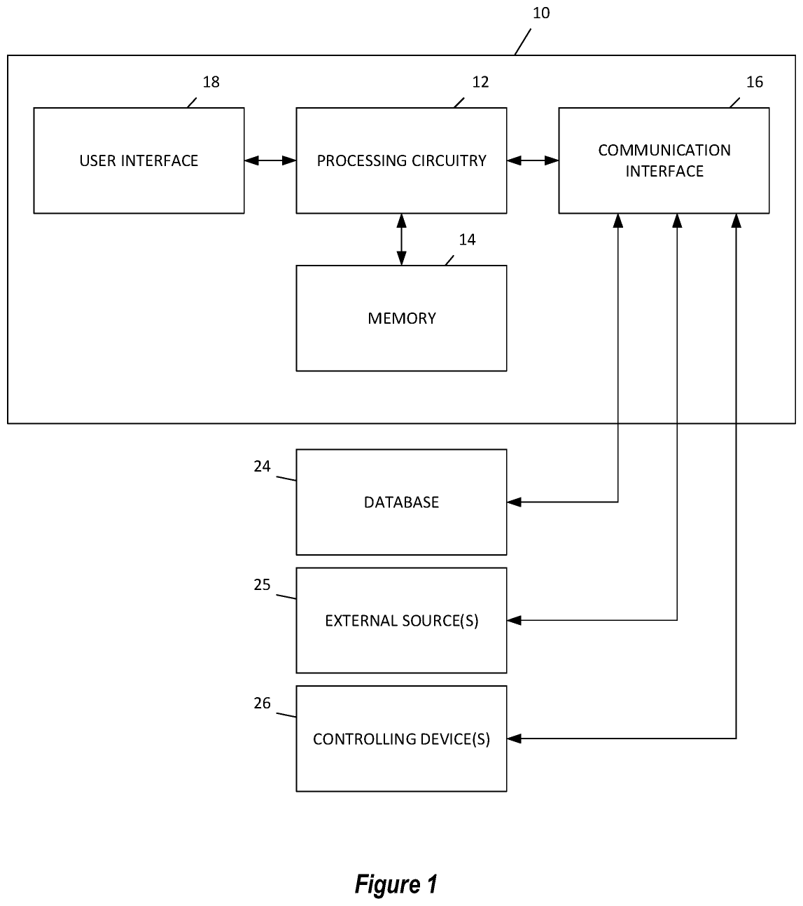

Regardless of the manner in which the apparatus is embodied, however, the apparatus 10 includes, is associated with, or is in communication with processing circuitry 12, memory 14, a communication interface 16 and optionally a user interface 18 as shown in FIG. 1. In some embodiments, the processing circuitry (and/or co-processors or any other processors assisting or otherwise associated with the processing circuitry) can be in communication with the memory via a bus for passing information among components of the apparatus. The memory can be non-transitory and can include, for example, one or more volatile and/or non-volatile memories. In other words, for example, the memory may be an electronic storage device (for example, a computer readable storage medium) comprising gates configured to store data (for example, bits) that can be retrievable by a machine (for example, a computing device like the processing circuitry). The memory can be configured to store information, data, content, applications, instructions, or the like for enabling the apparatus to carry out various functions in accordance with an example embodiment of the present disclosure. For example, the memory can be configured to buffer input data for processing by the processing circuitry. Additionally or alternatively, the memory can be configured to store instructions for execution by the processing circuitry.

The processing circuitry 12 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally or alternatively, the processing circuitry can include one or more processors configured in tandem via the bus to enable independent execution of instructions, pipelining and/or multithreading.

In an example embodiment, the processing circuitry 12 can be configured to execute instructions stored in the memory 14 or otherwise accessible to the processing circuitry. Alternatively or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 10 of an example embodiment can also include the communication interface 16 that can be any means such as a device or circuitry embodied in either hardware or a combination of hardware and software that is configured to receive and/or transmit data from/to other electronic devices in communication with the apparatus, such as one or more external sources 25, one or more controlling devices 26, and/or a database 24 which, in one embodiment, comprises a map database that stores data (e.g., map data, route data, etc.) generated and/or employed by the processing circuitry 12. Additionally or alternatively, the communication interface can be configured to communicate in accordance with various wireless protocols including Global System for Mobile Communications (GSM), such as but not limited to Long Term Evolution (LTE). In this regard, the communication interface can include, for example, an antenna (or multiple antennas) and supporting hardware and/or software for enabling communications with a wireless communication network. In this regard, the communication interface can include, for example, an antenna (or multiple antennas) and supporting hardware and/or software for enabling communications with a wireless communication network. Additionally or alternatively, the communication interface can include the circuitry for interacting with the antenna(s) to cause transmission of signals via the antenna(s) or to handle receipt of signals received via the antenna(s). In some environments, the communication interface can alternatively or also support wired communication and/or may alternatively support vehicle to vehicle or vehicle to infrastructure wireless links.

The external source(s) 25 may comprise an authoritative body associated with at least one autonomous transition region, as discussed further herein. The controlling device(s) 26 may be configured to implement one or more dynamic solutions based on a received recommendation, as further discussed herein. The controlling device(s) may, in some embodiments, be associated with the apparatus 10 such that the controlling device is embodied by the apparatus 10, however in some embodiments, the controlling device(s) 26 may be associated with one or more external source(s).

The map database of database 24 may include node data, road segment data or link data, point of interest (POI) data, traffic data or the like. The map database may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database can include data about the POIs and their respective locations in the POI records. The map database may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database. As noted above, the map database accessed by an apparatus 10 of an example embodiment includes information regarding one or more map objects including information regarding the type of map object and the location of the map object.

The map database of database 24 may be maintained by a content provider e.g., the map data service provider and may be accessed, for example, by the content or service provider processing server. By way of example, the map data service provider can collect geographic data and dynamic data to generate and enhance the map database and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as navigation devices onboard vehicles and/or mobile devices carried by passengers of a vehicle, as they travel the roads throughout a region.

The map database of database 24 may be a master map database, such as an HD map database, stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by a mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map database of database 24 may be a master geographic database, but in alternate embodiments, a client side map database may represent a compiled navigation database that may be used in or with end user devices to provide navigation and/or map-related functions. For example, the map database may be used with the mobile device to provide an end user with navigation features. In such a case, the map database can be downloaded or stored on the end user device which can access the map database through a wireless or wired connection, such as via a processing server and/or a network, for example.

The apparatus 10 may also optionally include a user interface 18 that may, in turn, be in communication with the processing circuitry 12 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processing circuitry may comprise user interface circuitry configured to control at least some functions of one or more user interface elements such as a display and, in some embodiments, a plurality of speakers, a ringer, one or more microphones and/or the like. The processing circuitry and/or user interface circuitry embodied by the processing circuitry may be configured to control one or more functions of one or more user interface elements through computer program instructions (for example, software and/or firmware) stored on a memory accessible to the processing circuitry (for example, memory 14, and/or the like).

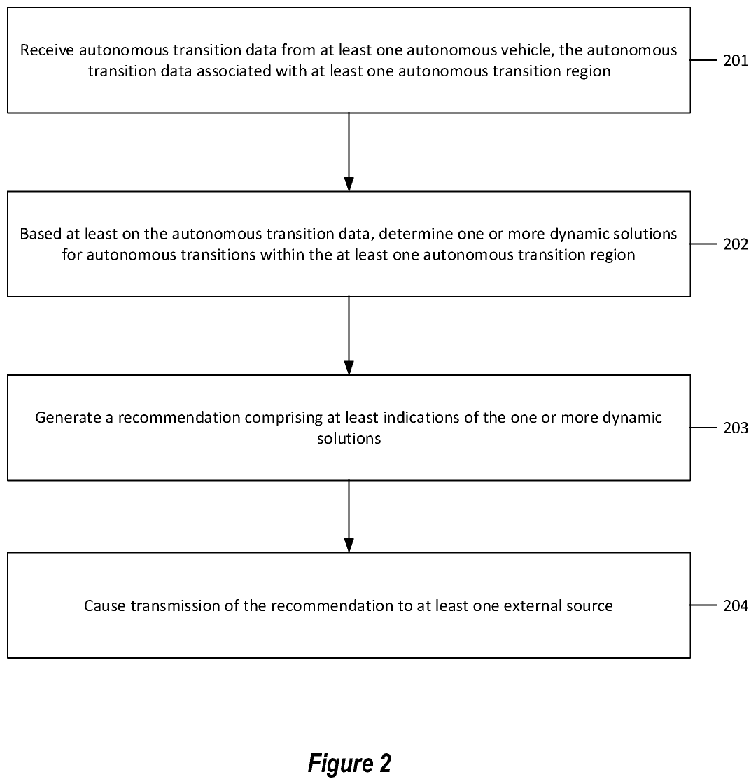

Referring now to FIG. 2, the operations performed, such as by the apparatus 10 of FIG. 1, in order to determine one or more dynamic solutions for autonomous transitions within at least one autonomous transition region are depicted. As shown in block 201, the apparatus includes means, such as the processing circuitry 12, memory 14, the communication interface 16 or the like, for receiving autonomous transition data from at least one autonomous vehicle. The autonomous transition data is associated with at least one autonomous transition region.

The autonomous transition data received from at least one autonomous vehicle may comprise a type of autonomous transition performed by the vehicle, a reason for the autonomous transition, a time of the autonomous transition, a location of the autonomous transition, and/or other information regarding one or more autonomous transitions. For example, data indicative of a type of autonomous transition may indicate whether the vehicle performed an engagement or a disengagement, and/or an autonomy level from which the vehicle transitioned from as well as an autonomy level to which the vehicle transitioned. Data indicative of a reason for the autonomous transition may indicate a reason as to why the engagement or disengagement took place. For example, the reason may, in some embodiments, be string text, such as “lacking 5G coverage,” “lane closure,” “construction zone,” and/or the like. In some embodiments, the reason may be associated with one or more weather conditions of the autonomous transition region, such as “icy/slippery roads,” “windy conditions,” and/or the like. In some embodiments, the reason may be a predefined numeric code indicative of a reason for an engagement or disengagement. Data indicative of a location of the autonomous transition may comprise a pair of latitude/longitude coordinates indicative of a location at which the autonomous transition took place. Data indicative of a time of the autonomous transition may comprise a timestamp indicative of when the autonomous transition took place.

In an embodiment, the received autonomous transition data associated with at least one autonomous transition region may be utilized to update one or more autonomous transition region parameters associated with a respective autonomous transition region of the at least one autonomous transition region. For example, the apparatus 10 may utilize the map database of database 24 described above to collect information regarding a plurality of autonomous transition regions associated with one or more routes. For example, data from a plurality of vehicles previously collected over time and aggregated may be stored in database 24 and analyzed to determine one or more autonomous transition regions. In this regard, the apparatus 10 includes means, such as the processing circuitry 12, memory 14 or the like, for determining, for a respective autonomous transition region, a plurality of autonomous transition region parameters. The one or more autonomous transition region parameters may comprise one or more of a disengagement reason, a current disengagement index value, an autonomous transition region start location, a severity categorization, a value representing a number of vehicles currently disengaged within the autonomous transition region, a value representing a current wait time, or the like.

A current disengagement index value may comprise a value on a scale (e.g., a value between 0 and 1) representative of a current condition of an associated disengagement region. For example, a higher current disengagement index may be indicative of a more severe condition of the disengagement region (e.g., a large amount of disengaged vehicles currently present within the disengagement region, inclement weather conditions present within the disengagement region, etc.). Conversely, a lower current disengagement index may be indicative of a less severe condition of the disengagement region (e.g., a small number of disengaged vehicles currently present within the disengagement region, short waiting times within the disengagement region, etc.). In addition to a current disengagement index value, a severity categorization may be determined based on the current disengagement index value. For example, the severity categorization may be a color-coded indication corresponding to the current disengagement index value. As one example, a high current disengagement index value (e.g., greater than 0.8) may correspond to a severity categorization of “red.” Likewise, a lower current disengagement index value (e.g., less than 0.3) may correspond to a severity categorization of “green.” In this regard, the severity categorization may provide a user-friendly and easily readable assessment of a particular candidate route. Further details regarding the disengagement index value are provided by U.S. patent application Ser. No. ______, filed ______, the entire contents of which are expressly incorporated by reference herein in their entirety.

The autonomous transition region start location may be identified in various manners, but, in one embodiment, comprises a pair of latitude and longitude coordinates corresponding to a location at which the autonomous transition region begins (e.g., a location at which a vehicle may disengage from or engage to one or more autonomous functionalities).

The value representing the number of vehicles currently disengaged within the autonomous transition region may be determined based on data from a plurality of disengaged vehicles within the autonomous transition region received by the apparatus and/or stored in database 24 or another computing device with which the apparatus is in communication. The value may be further based on timestamps associated with the received data. As an example, data received from vehicles that have not re-engaged autonomous functionalities and comprising timestamp values within a particular period of time (e.g., the previous hour) may be used to determine the value representing number of vehicles currently disengaged within the autonomous transition region. For example, the number of vehicles currently disengaged in the autonomous transition region (e.g., a disengagement region) may be 27 since of the 30 vehicles for which data has been received within the past hour indicating that autonomous functionalities have been disengaged, only 3 vehicles have re-engaged the autonomous functionalities.

The current wait time may comprise a value representing a length of time taken by a vehicle to exit a disengagement region after having disengaged autonomous functionalities upon entering the disengagement region. This value may be based on timestamped data received by the apparatus and/or stored in database 24 or other computing device from a plurality of vehicles that have traversed the disengagement region (e.g., vehicles that have disengaged upon entry into the disengagement region and re-engaged autonomous functionalities upon exiting the disengagement region). In an embodiment, the current wait time may be an averaged value based on wait times of a plurality of vehicles that have traversed the disengagement region. Other factors may contribute to the determination of the current wait time, such as a current number of vehicles currently disengaged within the disengagement region, weather conditions, and/or the like, relative to those same factors during the time period in which the averaged value was determined.

The disengagement reason may comprise a reason for which disengagement of autonomous functionalities of an autonomous vehicle is caused. As one example, a disengagement reason may comprise a string text value “lacking 5G coverage” indicative that cellular coverage is lacking within the disengagement region and that one or more vehicles are disengaged within the disengagement region due to insufficient network communication.

As shown in block 202, the apparatus includes means, such as the processing circuitry 12, memory 14, and/or the like, for determining one or more dynamic solutions for autonomous transitions within the at least one autonomous transition region. In some embodiments, the determination of one or more dynamic solutions for autonomous transitions within the at least one autonomous transition region is based at least on the autonomous transition data received from the at least one autonomous vehicle. In some embodiments, the determination of one or more dynamic solutions for autonomous transitions within the at least one autonomous transition region may be based or further be based on one or more updated parameters associated with the at least one autonomous transition region.

A dynamic solution may be a solution that can be implemented for the autonomous transition region dynamically in real-time or near real-time. Through implementation of a dynamic solution, autonomous transitions may be reduced or increased in a manner beneficial to travel along a route including a particular autonomous transition region. For example, implementation of a dynamic solution within an engagement region may result in an increased number of engagements, improving traffic flow and allow for more autonomy of vehicles. As another example, implementation of a dynamic solution within a disengagement region may result in a reduced number of disengagements, allowing for autonomous vehicles to maintain (or increase) their autonomy level, thereby improving traffic flow and reducing probability of congestion and neutralized/stranded vehicles.

One example of a dynamic solution is a real-time or near real-time traffic adjustment. For example, a real-time or near real-time traffic adjustment may comprise opening one or more lanes of traffic that were previously closed and/or otherwise unavailable to autonomous vehicles currently traversing the autonomous transition region. For example, a dynamic opening of a lane of traffic may comprise illuminating and/or displaying signage indicating that the one or more lanes of traffic are now open, and/or directing autonomous vehicles to maneuver into the now open lane. Another example of a real-time or near real-time traffic adjustment may comprise making a detour around the autonomous transition region available to one or more autonomous vehicles approaching or within the autonomous transition region. For example, a reason that autonomous vehicles may be disengaging within the autonomous transition region may be due to a fallen tree or other debris blocking one or more lanes of traffic. A dynamic detour may comprise illuminating and/or displaying signage indicating a detour is available, and/or directing autonomous vehicles to maneuver towards the detour. As another example, a dynamic solution in the form of a real-time or near real-time traffic adjustment may comprise a traffic speed reduction. For example, in certain instances such as during inclement weather (e.g., icy and/or wet roads), a reduction in speed of an autonomous vehicle may permit the autonomous vehicle to retain autonomous capabilities and not disengage. In this regard, a dynamic solution for a particular region experiencing inclement conditions may be to reduce the speed of some or all vehicles within the region.

Another example of a dynamic solution is a telecommunications network coverage increase. For example, in the event of one or more vehicles experiencing disengagements related to lack of 5G coverage within an area, the apparatus 10 may determine that a dynamic solution that would reduce the disengagements within the area and allow for vehicles to maintain or increase autonomy levels would be to increase telecommunications network coverage within the area. As one example, a dynamic solution may comprise deploying one or more temporary drones or the like to the autonomous transition region in order to magnify telecommunications network coverage within the area. In this regard, vehicles may be better able to communicate with a telecommunications network and avoid autonomous functionality interruption.

At block 203, the apparatus includes means, such as the processing circuitry 12, memory 14, and/or the like, for generating a recommendation comprising at least indications of the one or more dynamic solutions. For example, in some embodiments, indications and/or information related to the determined one or more dynamic solutions may be packaged into a recommendation which may then be transmitted to a source associated with the autonomous transition region and capable of implementing the dynamic solutions. The recommendation may, in some embodiments, be a data structure comprising information related to the one or more dynamic solutions configured to be received and processed by an external source 25, controlling device, and/or other source associated with the at least one autonomous transition region.

At block 204, the apparatus includes means, such as the processing circuitry 12, memory 14, communication interface 16 and/or the like, for causing transmission of the recommendation to at least one external source.

In some embodiments, the at least one external source may comprise an authoritative body associated with the at least one autonomous transition region. For example, the authoritative body may be a governmental agency and/or the like responsible for maintaining a region of roadways or the like in which the at least one autonomous transition regions are located. The authoritative body may be responsible for implementing traffic adjustments, such as lane closures, lane openings, and/or detours, traffic lights and signage, and/or other traffic-related duties. In some embodiments, the at least one external source may comprise a telecommunications company responsible for providing cellular coverage or the like to the at least one autonomous transition region.

In some embodiments, the apparatus includes means, such as the processing circuitry 12, memory 14, communication interface 16 and/or the like, for causing transmission of the recommendation to at least one controlling device. In some embodiments, the at least one controlling device comprises a controlling device associated with an external authoritative body associated with the at least one autonomous transition region. In some embodiments, the at least one controlling device is not associated with an external source, but rather is associated with the apparatus 10. In this regard, the controlling device associated with the apparatus 10 may be configured to implement one or more dynamic solutions based on a received recommendation.

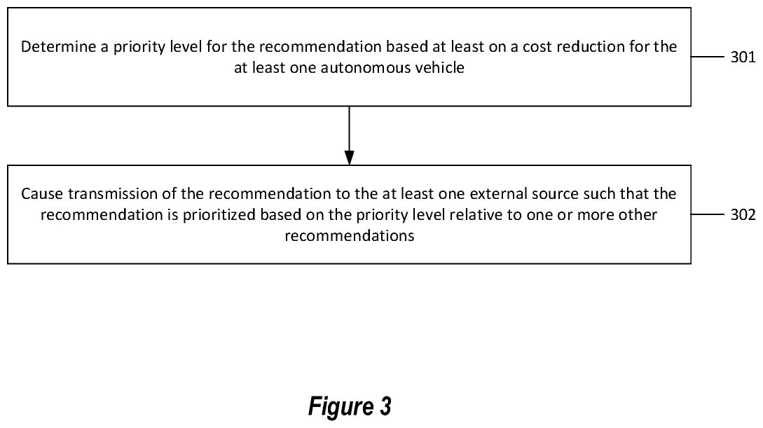

Referring now to FIG. 3, the operations performed, such as by the apparatus 10 of FIG. 1, in order to determine a priority level for a recommendation are depicted. As shown in block 301, the apparatus includes means, such as the processing circuitry 12, memory 14, and/or the like, for determining a priority level for the recommendation based at least on a cost reduction for the at least one autonomous vehicle.

For example, a priority level may be a data value indicative of a priority for one or more dynamic solutions of a recommendation to be implemented relative to implementation of other dynamic solutions of other recommendations, such as dynamic solutions for the same or other autonomous transition regions. As one example, a priority level of “1” may indicate that the recommendation is a high priority and should be implemented prior to recommendations having priority levels greater than “1.”

The determination of a priority level for the recommendation may be based at least on a cost reduction for the at least one autonomous vehicle. For example, one or more autonomous vehicles disengaged within a disengagement region and unable to move forward due to a fallen tree and/or other debris within the road may incur both increased monetary and temporal costs due to the disengagement. For example, the one or more autonomous vehicles may be ride-share and/or taxi vehicles associated with a monetary cost that a user incurs based on an amount of time that the user utilizes the autonomous vehicle (e.g., a cost-per-hour). In this regard, remaining stationary and/or disengaged due to the debris negatively impacts the user of the autonomous vehicle by increasing time spent within the autonomous vehicle and therefore increasing the monetary cost associated with the autonomous vehicle. Similarly, a temporal cost to the user is incurred, increasing the travel time and delaying the arrival time to an intended destination.

In this regard, a dynamic solution to the above example may comprise opening a detour around the fallen debris, and the dynamic solution of opening the detour may comprise a greater cost reduction than, for example, another recommendation comprising a dynamic solution of opening an extra lane to congested, yet still-flowing, traffic. In this regard, the stand-still traffic due to the fallen debris will incur a greater cost than slow-moving traffic due to a lane closure. Thus, the recommendation comprising the detour opening will have a higher priority level than the recommendation comprising the lane-opening.

In some embodiments, determination of a priority level for a recommendation may be based or be further based on a vehicle count associated with a disengagement region.

TABLE A

| | Vehicle | Timestamp of Most Recent |
|---|---|---|
| Disengage Reason | Count | Disengagement |
| Loss of 5G | 52 | 1:00 |
| Degraded Lane Marking | 103 | 2:05 |
| Slippery Road Conditions | 1 | 2:14 |

For example, in Table A, three disengagement reasons associated with a particular disengagement region are shown. In the example, 52 vehicles have disengaged due to a loss of 5G coverage, 103 vehicles have disengaged due to degraded lane markings, and 1 vehicle has disengaged due to inclement conditions (e.g., slippery roads). In this regard, a recommendation comprising a dynamic solution to the degraded lane marking may be assigned a higher priority level than recommendations comprising dynamic solutions to the loss of 5G coverage or slippery road conditions.

In some embodiments, determination of a priority level for a recommendation may be based or be further based on a timestamp of a most recent disengagement associated with a disengagement region. In this regard, continuing with the example shown in Table A, a recommendation comprising a dynamic solution to the slippery road conditions may be assigned a higher priority level than recommendations comprising dynamic solutions to the loss of 5G coverage or degraded lane marking.

As shown in block 302, the apparatus includes means, such as the processing circuitry 12, memory 14, the communication interface 16 or the like, for causing transmission of the recommendation to the at least one external source such that the recommendation is prioritized based on the priority level relative to one or more other recommendations. In this regard, a recommendation comprising a higher priority level relative to other recommendations may be transmitted to the external source prior to other recommendations. Inclusion of a priority level with the recommendation may serve to indicate to the external source that the dynamic solution associated with the prioritized recommendation should be implemented prior to other received recommendations.

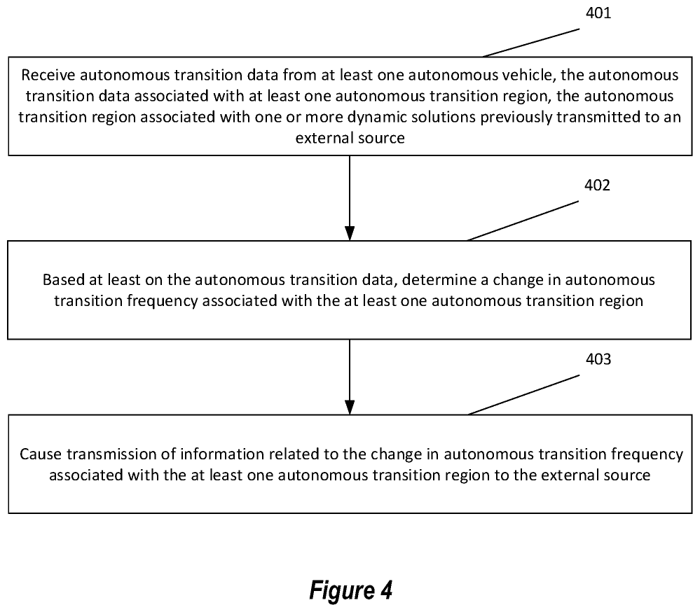

Referring now to FIG. 4, the operations performed, such as by the apparatus 10 of FIG. 1, in order to determine and provide information related to a change in autonomous transition frequency are depicted. For example, after causing transmission of a recommendation to an external source and/or controlling device, the apparatus 10 may continue to receive autonomous transition data from one or more autonomous vehicles and update one or more parameters associated with the at least one autonomous transition region based at least on the received autonomous transition data. In this regard, the apparatus 10 can monitor the continuously received autonomous transition data to determine whether a dynamic solution was implemented and/or if the dynamic solution was effective.

As shown in block 401, the apparatus includes means, such as the processing circuitry 12, memory 14, communication interface 16 and/or the like, for receiving autonomous transition data from at least one autonomous vehicle. The received autonomous transition data is associated with at least one autonomous transition region that is associated with one or more dynamic solutions previously transmitted to an external source (or controlling device). As described above, the autonomous transition data may comprise a type of autonomous transition performed by the vehicle, a reason for the autonomous transition, a time of the autonomous transition, a location of the autonomous transition, and/or other information regarding one or more autonomous transitions.

As shown in block 402, the apparatus includes means, such as the processing circuitry 12, memory 14, and/or the like, for determining a change in autonomous transition frequency associated with the at least one autonomous transition region. The determination of a change in autonomous transition frequency, such as a change in the percentage of autonomous vehicles that undergo an autonomous transition associated with the at least one autonomous transition region may be based at least on the received autonomous transition data. For example, an amount of autonomous transitions associated with autonomous transition data received after a recommendation has been transmitted to an external source and/or controlling device may be compared to an amount of autonomous transitions associated with autonomous transition data received after a recommendation has been transmitted to determine if autonomous transitions have increased, decreased, or remained constant following the transmission of the recommendation.

For example, a reduced amount of disengagement for a disengagement region may indicate that the dynamic solution was effective in resolving a reason for disengagements occurring within the disengagement region. Likewise, an increased amount of engagements for an engagement region may indicate that the dynamic solution was effective in permitting engagements to occur within the engagement region.

As shown in block 403, the apparatus includes means, such as the processing circuitry 12, memory 14, communication interface 16 and/or the like, for causing transmission of information related to the change in autonomous transition frequency associated with the at least one autonomous transition region to the external source (or controlling device). In this regard, an external source, such as an authoritative body, may be notified of the change in autonomous transition frequency such that the external source is made aware that the dynamic solutions implemented by the external source have been successful or, alternatively, have been unsuccessful such that other solutions, such as other dynamic solutions have a lower priority, may be implemented.

As described above, a method, apparatus and computer program product to identify and provide dynamic solutions to improve autonomous transition regions are provided. By identifying dynamic solutions and analyzing resulting autonomous transition region behavior, congestion along roadways may be alleviated, a safe and improved ride experience for passengers of autonomous vehicles may be provided, and load upon a network may be reduced.

FIGS. 2-4 illustrate flowcharts depicting a method according to an example embodiment of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus 10 employing an embodiment of the present invention and executed by the processing circuitry 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory storing computer program code, the at least one memory and the computer program code configured to, with the processor, cause the apparatus to at least:
receive autonomous transition data from at least one autonomous vehicle, the autonomous transition data associated with at least one autonomous transition region;
based at least on the autonomous transition data, determine one or more dynamic solutions for autonomous transitions within the at least one autonomous transition region;
generate a recommendation comprising at least indications of the one or more dynamic solutions; and
cause transmission of the recommendation to at least one external source.

2. The apparatus according to claim 1, wherein the at least one memory and the computer program code are further configured to, with the processor, cause the apparatus to:
update one or more parameters associated with the at least one autonomous transition region based at least on the received autonomous transition data.

3. The apparatus according to claim 2, wherein the one or more dynamic solutions are determined based further on the one or more updated parameters associated with the at least one autonomous transition region.

4. The apparatus according to claim 1, wherein the one or more dynamic solutions comprise a real-time or near real-time traffic adjustment, and
wherein the at least one external source comprises an authoritative body associated with the at least one autonomous transition region.

5. The apparatus according to claim 1, wherein the at least one memory and the computer program code configured to cause transmission of the recommendation to the at least one external source are further configured to, with the processor, cause the apparatus to:
determine a priority level for the recommendation based at least on a cost reduction for the at least one autonomous vehicle; and
cause transmission of the recommendation to the at least one external source such that the recommendation is prioritized based on the priority level relative to one or more other recommendations.

6. The apparatus according to claim 5, wherein the cost reduction comprises at least one of a monetary cost or a temporal cost.

7. The apparatus according to claim 1, wherein the one or more dynamic solutions comprise a telecommunications network coverage increase, and
wherein the at least one external source comprises a telecommunications service provider.

8. A method comprising:
receiving autonomous transition data from at least one autonomous vehicle, the autonomous transition data associated with at least one autonomous transition region;
based at least on the autonomous transition data, determining one or more dynamic solutions for autonomous transitions within the at least one autonomous transition region;
generating a recommendation comprising at least indications of the one or more dynamic solutions; and
causing transmission of the recommendation to at least one controlling device.

9. The method according to claim 8, further comprising:
updating one or more parameters associated with the at least one autonomous transition region based at least on the received autonomous transition data.

10. The method according to claim 9, wherein the one or more dynamic solutions are determined based further on the one or more updated parameters associated with the at least one autonomous transition region.

11. The method according to claim 8, wherein the one or more dynamic solutions comprise a real-time or near real time traffic adjustment, and
wherein the at least one controlling device comprises a controlling device associated with an external authoritative body associated with the at least one autonomous transition region.

12. The method according to claim 8, wherein causing transmission of the recommendation to the at least one controlling device further comprises:
determining a priority level for the recommendation based at least on a cost reduction for the at least one autonomous vehicle; and
causing transmission of the recommendation to the at least one controlling device such that the recommendation is prioritized based on the priority level relative to one or more other recommendations.

13. The method according to claim 12, wherein the cost reduction comprises at least one of a monetary cost reduction or a temporal cost reduction.

14. The method according to claim 8, wherein the one or more dynamic solutions comprise at least one of a telecommunications network coverage increase or real-time or near real time traffic adjustment.

15. An apparatus comprising at least one processor and at least one memory storing computer program code, the at least one memory and the computer program code configured to, with the processor, cause the apparatus to at least:
receive autonomous transition data from at least one autonomous vehicle, the autonomous transition data associated with at least one autonomous transition region, the autonomous transition region associated with one or more dynamic solutions previously transmitted to an external source;
based at least on the autonomous transition data, determine a change in autonomous transition frequency associated with the at least one autonomous transition region; and
cause transmission of information related to the change in autonomous transition frequency associated with the at least one autonomous transition region to the external source.

16. The apparatus according to claim 15, wherein the change in autonomous transition frequency associated with the at least one autonomous transition region comprises a reduced amount of autonomous transitions within the autonomous transition region.

17. The apparatus according to claim 15, wherein the at least one memory and the computer program code are further configured to, with the processor, cause the apparatus to:
update one or more parameters associated with the at least one autonomous transition region based at least on the received autonomous transition data.

18. The apparatus according to claim 15, wherein the at least one memory and the computer program code are further configured to, with the processor, cause the apparatus to: utilize a routing algorithm to determine one or more routes comprising the at least one autonomous transition region.

19. The method according to claim 15, wherein the one or more dynamic solutions comprise a telecommunications network coverage increase.

20. The method according to claim 15, wherein the one or more dynamic solutions comprise a real-time or near real-time traffic adjustment.
